(19) United States
(12) Patent Application Publication
(10) Pub. No.: US 2019/0186342 A1
(43) Pub. Date: Jun. 20, 2019

(54) Method for Operating an Internal Combustion Engine, and Internal Combustion Engine

(71) Applicant: Daimler AG, Stuttgart (DE)

(72) Inventor: Herbert ZOELLER, Stuttgart (DE)

(73) Assignee: Daimler AG, Stuttgart (DE)

(21) Appl. No.: 16/326,115

(22) PCT Filed: Jul. 14, 2017
(86) PCT No.: PCT/EP2017/000847

§ 371 Date: Feb. 15, 2019

(30) Foreign Application Priority Data
Aug. 16, 2016 (DE) 10 2016 009 971.2

(51) Int. Cl. F02B 23/06; F02M 61/18

(52) U.S. Cl. CPC F02B 23/0651; F02B 23/0624; F02M 61/1806; F02B 23/0693; F02B 23/0669

(57) ABSTRACT

A method for operating an internal combustion engine includes using a 3-front combustion method. When the fuel is injected into the combustion chamber the fuel flows through an injection element with a hydraulic flow of more than 1000 cubic centimeters per 60 seconds and under an injection pressure of 100 bar and 1 liter capacity per cylinder if the internal combustion engine is used in a truck application. The fuel flows through the injection element with a hydraulic flow of more than 1900 cubic centimeters per 60 seconds and under an injection pressure of 100 bar and 1 liter capacity per cylinder if the internal combustion engine is used in a car application.

### BACKGROUND AND SUMMARY OF THE INVENTION

The invention relates to a method for operating an internal combustion engine and to an internal combustion engine.

Such a method for operating an internal combustion engine and such an internal combustion engine are already known from DE 10 2011 119 215 A1 and DE 10 2006 020 642 A1. The internal combustion engine comprises direct fuel injection and self-ignition and is therefore formed as a direct injection, self-igniting internal combustion engine. In this case, the internal combustion engine comprises at least one cylinder, the combustion chamber of which is laterally delimited by a cylinder wall, is axially delimited on one side by a cylinder head and is axially delimited on the other side by a piston that is retained in the cylinder such that it can move in a translational manner. The cylinder wall defines a central longitudinal axis of the cylinder, for example. Furthermore, the internal combustion engine comprises an injection element that is assigned to the cylinder, which is also referred to as an injector or injection nozzle. In this case, it is conceivable for the injection element to be arranged coaxially with the combustion chamber or at least substantially coaxially with the central longitudinal axis. In particular, it is conceivable for at least part, in particular at least most or all, of the injection element to be arranged in the cylinder head.

The piston comprises an annularly circumferential piston step, which is axially sunk in the piston with respect to an annularly circumferential piston crown and transitions into a piston bowl that is axially sunk in the piston with respect to the piston step by means of an annularly circumferential jet splitter contour. The injection element is designed such that it can inject a plurality of injection jets into the combustion chamber at the same time in the shape of a star for the purpose of a combustion process. Within the context of the method, a plurality of injection jets are therefore simultaneously injected into the combustion chamber in the shape of a star by means of the injection element for the purpose of a combustion process during a self-igniting operation of the internal combustion engine, wherein the particular injection jet can be at least substantially conical, for example. The method is a combustion method, within the scope of which the particular injection jets are each divided up at the jet splitter contour into a first fuel portion, a second fuel portion and into respective third fuel portions. In other words, the particular injection jet comprises fuel, which is directly injected into the combustion chamber by means of the injection jet. The portions are therefore also referred to as fuel portions.

The first portion at least substantially enters the piston bowl. The second portion at least substantially enters a region between the piston crown and the cylinder head via the piston step. The third portions propagate, starting from the particular injection jet, in opposite directions on both sides in the circumferential direction of the piston along the piston step and collide with one another inside the piston step. Furthermore, the third portions are deflected radially inwards. The third portions are formed and guided by the injection jets impinging on the jet splitter contour into the piston step. The first portion and the second portion form a first combustion front and a second combustion front. As a result of the third portions moving away from the piston step, a third combustion front is formed, which propagates substantially radially into a gap that is formed in the circumferential direction between adjacent injection jets. Such a combustion method can also be referred to as a “3-front combustion method” or as TFC (triple front combustion), since substantially three combustion fronts or flame fronts spatially propagate in the combustion chamber for each injection jet in each case.

Since the combustion fronts effectively use the space available in the combustion chamber, by means of the combustion method, a large amount of the unburnt gas or unburnt gas-exhaust gas mixture available in the combustion chamber is used, which in particular considerably reduces the soot formation from the combustion process. Furthermore, by means of the third combustion front which burns with a time delay with respect to the two first combustion fronts, the temperature of the combustion chamber decreases, and therefore the formation of nitric oxide (NOₓ formation) does not increase.

In order to form the third combustion front, the third portions of adjacent injection jets meet in the piston step with a large amount of momentum. The momentum of the third portions is formed from the product of the mass of the third portions and the speed thereof. If the momentum of the third portions is large enough, the third portions are deflected into the combustion chamber when they meet. In this case, the respective third portions that are collectively deflected can form a third combustion front, which is substantially oriented in the direction of the central longitudinal axis between the respective injection jets. The third combustion front advantageously produces a large amount of turbulence in the combustion chamber, therefore increasing the compatibility for exhaust gas circulated back into the combustion chamber, as a result of which NOₓ emissions can be further reduced by means of the increased EGR proportion in the combustion chamber.

The object of the present invention is to develop a method and an internal combustion engine of the type mentioned at the outset so as to allow for operation that is particularly favorable with regards to efficiency.

In order to develop a method such that the internal combustion engine can be operated in a manner that is particularly favorable with regards to efficiency, according to the invention, when the fuel is injected into the combustion chamber, the fuel, which is preferably liquid, flows through the injection element with a hydraulic flow (HF) of more than 1000 cm³ (cubic centimeters) per 60 seconds and under an injection pressure of 100 bar and 1 liter capacity per cylinder for truck applications, and of more than 1900 cm³ per 60 seconds and under an injection pressure of 100 bar and 1 liter capacity per cylinder for car applications. The invention is based on a 3-front combustion method, within the context of which the three combustion fronts are formed. The injection jets emanating from injection openings in the injection element, which is also referred to as an injector or injection nozzle, for example, impinge on the jet splitter contour or on the piston step and are deflected such that the combustion fronts, which are also referred to as flame fronts, propagate, the third combustion front forming on the radial inside in a gap between the injection jets and using combustion air present therein for the combustion process. As a result, soot emissions can be minimized. In addition, the fuel consumption of the internal combustion engine can be kept within a particularly small range.

The invention is based on the understanding that the efficiency of an internal combustion engine, which comprises direct fuel injection and self-ignition, i.e., is formed as a direct injection and self-igniting internal combustion engine, can be improved by increasing the compression ratio and by shortening the burn time. However, when the compression ratio is increased, less and less of the combustion chamber is available so that less space is available for the flame and the jets or flame fronts reach the combustion chamber wall (cylinder head, cylinder wall and piston) quicker, where they lead to soot formation due to the lower temperature, thus increasing soot emissions. The burn time can be shortened by increasing the hydraulic flow of the injection element. By increasing the hydraulic flow of the injection element, the quantity injected per unit of time is increased. Using the methods known thus far for operating an internal combustion engine, it was not possible to fully burn such a larger quantity of fuel injected per unit of time above a certain value, and led to increased soot emissions. The hydraulic flow can be increased by larger injection openings or by larger cross sections of the injection openings in the injection element. Until now, it has been assumed that a hydraulic flow of up to 1000 cm³ per 60 seconds and under an injection pressure of 100 bar and 1 liter capacity per cylinder for truck applications and a maximum of 1900 cm³ per 60 seconds and under an injection pressure of 100 bar and 1 liter capacity per cylinder for car applications does not lead to increased soot formation. Using the 3-front combustion method, however, it is now possible to increase the former threshold value, which was 1000 cm³ per 60 seconds for the hydraulic flow, 100 bar for the injection pressure and 1 liter capacity per cylinder for internal combustion engines for truck applications, and to increase the former threshold value, which was 1900 cm³ per 60 seconds for the hydraulic flow, 100 bar for the injection pressure and 1 liter capacity per cylinder for internal combustion engines for car applications, without increasing soot formation. By means of the improved use of the combustion air in the combustion chamber, which use can be achieved by the 3-front combustion method, a particularly high hydraulic flow of the injection element can be achieved. Furthermore, this allows for an operation that is particularly advantageous with regards to efficiency. In particular, it has been found that the efficiency in comparison with conventional internal combustion engines can be increased by approximately 1.3% from the increase in the compression ratio and by approximately 0.6% from the reduction in the burn time, without leading to an undesirable increase in soot emissions alongside constant NOₓ emissions.

In this case, a distinction is made between internal combustion engines for truck applications and for car applications. The hydraulic flows for injection elements for internal combustion engines in truck applications and car applications differ considerably in principle. The certification and exhaust emissions legislation for the respective motor vehicle types has a specific influence on the applicable maximum hydraulic flow of an injection element. In general, motor vehicles having a permissible overall weight of 2.80 tons and a payload of more than 800 kg are considered to be a truck. Cars generally have a permissible overall weight of no more than 2.8 tons. Combustion in combustion engines for truck applications is produced, inter alia, by the soot emissions of the internal combustion engine reaching a blackening rate (BR) of no more than 0.8. In contrast, combustion in internal combustion engines in car applications is produced, inter alia, by the blackening rate (BR) of the soot emissions of the internal combustion engine reaching a maximum value of 3.0. The blackening rate BR is a measure of the soot emissions of an internal combustion engine, which is directly dependent on the hydraulic flow of injection elements. These considerably different blackening rates are caused by the different certification and exhaust emissions regulations with customer-specific requirements, such as a certain power that is required and starting torque, playing a major role. For example, a specific power for truck applications can be 35 KW per liter capacity whereas a specific power for car applications can be up to 100 KW per liter capacity. It is clear here that higher specific powers having a greater quantity of fuel injected per unit of time can be achieved such that in particular the hydraulic flow of an injection element is adapted accordingly and thereby at higher hydraulic flows (HF) the blackening rate (BR) or soot emissions increase. In general, the hydraulic flow (HF) is given standardized to a fuel volume (cm³) per unit of time (60 seconds) and under a constant injection pressure (100 bar) in a cylinder having 1 liter capacity.

It is clear that motor vehicles up to a permissible total weight of 3.5 tons, for example, in particular transporters, can also be equipped with an internal combustion engine, which was originally provided for a car application. It may be the case here that an internal combustion engine, which was originally for car applications, is implemented in a truck application without any specific changes to combustion, and therefore the blackening rate (BR) for these vehicles lies in the range for truck applications, as a result of which, according to the present invention, motor vehicles having a permissible overall weight of up to 3.5 tons, for example, and having an internal combustion engine that was originally for use in cars, can be assigned to use in trucks.

Another embodiment is characterized in that the internal combustion engine is operated with a compression ratio assigned to the combustion chamber of at least 20, in particular at least 20.5. Since within the scope of the method according to the invention the combustion air in the combustion chamber can be used particularly effectively, the compression ratio can be increased in comparison with convention internal combustion engines by approximately two units, to approximately 20.3, in particular to 20.5, it being possible to achieve a particularly high hydraulic flow of the injection element at the same time. As a result, in comparison with conventional internal combustion engines, the efficiency can be markedly increased while the soot and NOₓ emissions remain the same.

In particular, by means of the 3-front combustion method and an optimized swirl flow, the air is used up effectively and recirculated exhaust gas, air and fuel are effectively mixed in the combustion chamber, it being possible to further optimize the thermal efficiency of the internal combustion engine by increasing the compression ratio without a considerable increase in soot emissions. By using the injection element having the high hydraulic flow, the burn time can be considerably shorter than in conventional internal combustion engines. As a result, the combustion method or a combustion process taking place in the combustion chamber approximates the ideal Otto cycle, which can further increase the efficiency. As a result, fuel consumption and therefore CO₂ emissions of the internal combustion engine can be kept in a particularly small range.

In order to develop an internal combustion engine such that a particularly high degree of efficiency can be achieved, according to the invention when the fuel is injected into the combustion chamber, the fuel flows through the injection element having a hydraulic flow of more than 1000 cm³ per 60 seconds and under 100 bar injection pressure and 1 liter capacity per cylinder for truck applications and more than 1900 cm³ per 60 seconds and under 100 bar injection pressure and 1 liter capacity per cylinder for car applications. Advantages and advantageous embodiments of the method according to the invention can be considered to be advantages and advantageous embodiments of the internal combustion engine according to the invention, and vice versa.

Further advantages, features and details of the invention can be found in the following description of a preferred embodiment and on the basis of the drawings. The features and combinations of features mentioned above in the description and the features and combinations of features mentioned below in the description of the figures and/or shown in the figures alone can be used not only in the combination given in each case, but also in other combinations or in isolation, without leaving the scope of the invention.

### BRIEF DESCRIPTION OF THE DRAWINGS

FIG. 1 is a cut-out of a schematic longitudinal sectional view of an internal combustion engine for a motor vehicle;

FIG. 2 is a schematic plan view of a piston of the internal combustion engine;

FIGS. 3a-c are each cut-outs of a schematic half longitudinal sectional view of the piston in different states of a combustion method, formed as a 3-front combustion method, of the internal combustion engine;

FIGS. 4a-c are each cut-outs of a schematic plan view of the piston in the different states of the combustion method;

FIG. 5 is a cut-out of a schematic longitudinal sectional view of an injection element for directly injecting fuel into a cylinder of the internal combustion engine, in which the combustion method is carried out;

FIG. 6 is a graph showing a method for operating the internal combustion engine, wherein the 3-front combustion method is carried out within the scope of the method;

FIG. 7 is another graph showing the method for operating the internal combustion engine;

FIG. 8 is another graph showing the method for operating the internal combustion engine; and

FIG. 9 is another graph showing the method.

### DETAILED DESCRIPTION OF THE DRAWINGS

In the figures, elements that are the same or have the same function are provided with the same reference numerals.

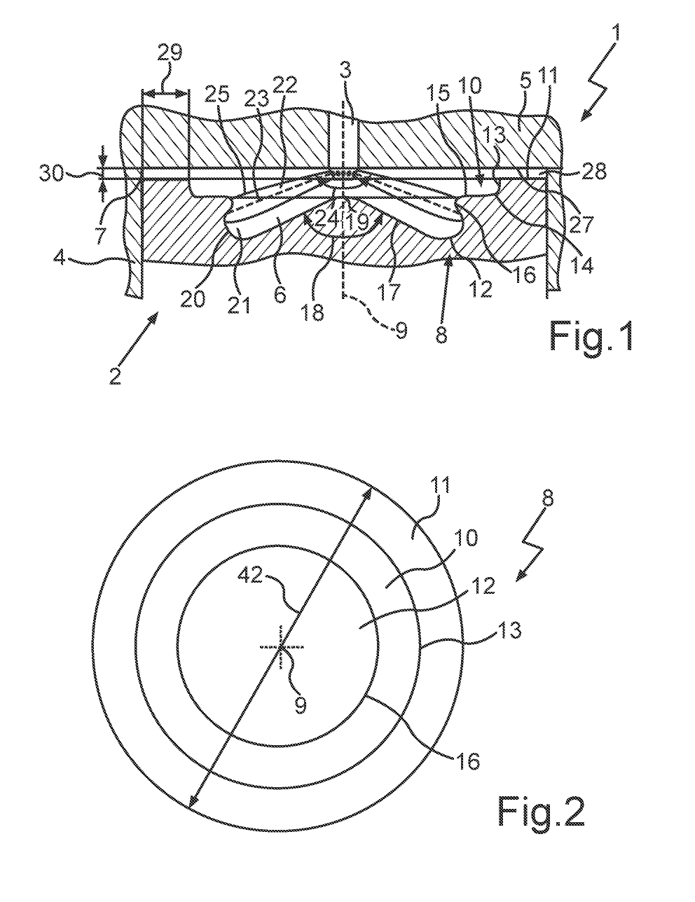

According to FIG. 1, an internal combustion engine 1, which in particular is also referred to as an internal combustion engine and can be used in a motor vehicle, specifically in both a commercial vehicle and a passenger vehicle, comprises at least one cylinder 2 and an injection nozzle 3 of an injector (not shown in more detail) for each cylinder 2. The injection nozzle 3 is also referred to as an injection element or injector. In FIG. 1, the internal combustion engine 1 is only shown in the region of such a cylinder 2. In principle, the internal combustion engine 1 can also comprise more than one cylinder 2. The particular cylinder 2 is formed in a crankcase 4, on which a cylinder head 5 is normally arranged.

In the particular cylinder 2, a combustion chamber 6 is laterally delimited by a cylinder wall 7 and is axially delimited on one side by the cylinder head 5 and axially delimited on the other side by a piston 8, which is arranged or retained in the cylinder 2 such that the stroke can be adjusted or such that it can move in a translational manner. The cylindrical cylinder wall 7 defines a central longitudinal axis 9 of the cylinder 2. In the example, the injection nozzle 3 is arranged coaxially to the combustion chamber 6 in the cylinder head 5.

According to FIG. 1 and FIG. 2, the piston 8 is designed as a stepped piston. Such a step piston 8 comprises an annularly circumferential piston step 10 with respect to the central longitudinal axis 9, an annularly circumferential piston crown 11 with respect to the central longitudinal axis 9, and a piston bowl 12, which is arranged coaxially with the central longitudinal axis 9. In this case, the piston step 10 is formed or arranged so as to be axially sunk in the piston 8 with respect to the piston crown 11. The piston bowl 12 is formed or arranged so as to be axially sunk in the piston 8 with respect to the piston step 10. The cross section of the piston step 10 is angular and axially comprises a circumferential step wall 13, which transitions into a radially planar step bottom 15 via a concave transition wall 14. The step wall 13 transitions into the planar piston crown 11. A rounded edge region, which is referred to as the jet splitter contour 16 in the following, adjoins the step bottom 15 and transitions into the deeper piston bowl 12. The step wall 13, the transition wall 14, the step bottom 15 and the jet splitter contour 16 are designed so as to be annularly, in particular circularly, circumferential with respect to the central longitudinal axis 9.

The piston 8 also comprises a piston cone 17, which is molded coaxially and concentrically inside the piston bowl 12. The piston cone 17 comprises a cone angle 18 and tapers towards the cylinder head 5. A cone tip 19 is arranged so as to be sunk in the piston 8 with respect to the piston crown 11. In the embodiment, the piston crown 11 extends in a plane that runs perpendicularly to the central longitudinal axis 9. The substantial region of the piston step 10 also extends in a plane that is perpendicular to the central longitudinal axis 9.

In the embodiment according to FIG. 1, the jet splitter contour 16 slightly protrudes beyond a radially external outer wall 20 of the piston bowl 12 and faces radially inwards. The piston recess 12 therefore comprises an undercut 21 with respect to the jet splitter contour 16.

The jet splitter contour 16 is in the form of a rounded, annularly circumferential projection between the step bottom 15 and the outer wall 20 of the piston bowl 12. In the absence of an undercut 21, the jet splitter contour 16 can also be formed as a rounded, annularly circumferential edge between the step bottom 15 and the outer wall 20 of the piston bowl 12, which edge substantially has a rectangular cross section.

As shown in FIG. 1, the injection nozzle 3 is designed such that it can produce a plurality of injection jets 22 at the same time, which propagate, in the shape of a star with respect to the central longitudinal axis 9, from the injection nozzle 3 and substantially radially into the combustion chamber 6. It is essential that the injection jets 22 propagate coaxially with the central longitudinal axis 9 the further away they get in the radial direction. The particular injection jet 22 occurs along an inclined central longitudinal axis 23 that defines a propagation direction of the particular injection jet 22. The injection jets 22 in their entirety have a cone contour, which comprises a jet cone angle 24. The individual injection jets 22 each propagate inside the combustion chamber 6 in the shape of a club. A corresponding club contour is denoted in FIG. 1 by reference numeral 25. For the following consideration, the individual injection jets 22 and the resultant additional jets or portions are shown in a simplified manner as arrows. It is clear that the injection jet 22 and the individual portions separating from the injection jet 22 each represent a propagating fuel vapor cloud or a cloud of combustion air and fuel, which can in particular react, at least on its outside, with the oxygen in the combustion chamber 6 and therefore forms a flame front or a burning fuel-air mixture. It is also clear that the injection jet 22 first carries fuel in largely liquid form substantially along its central longitudinal axis 23 and only forms an air-fuel mixture at its edges together with the combustion air in the combustion chamber 6, the liquid fuel being further evaporated and mixing with the combustion air during the combustion process.

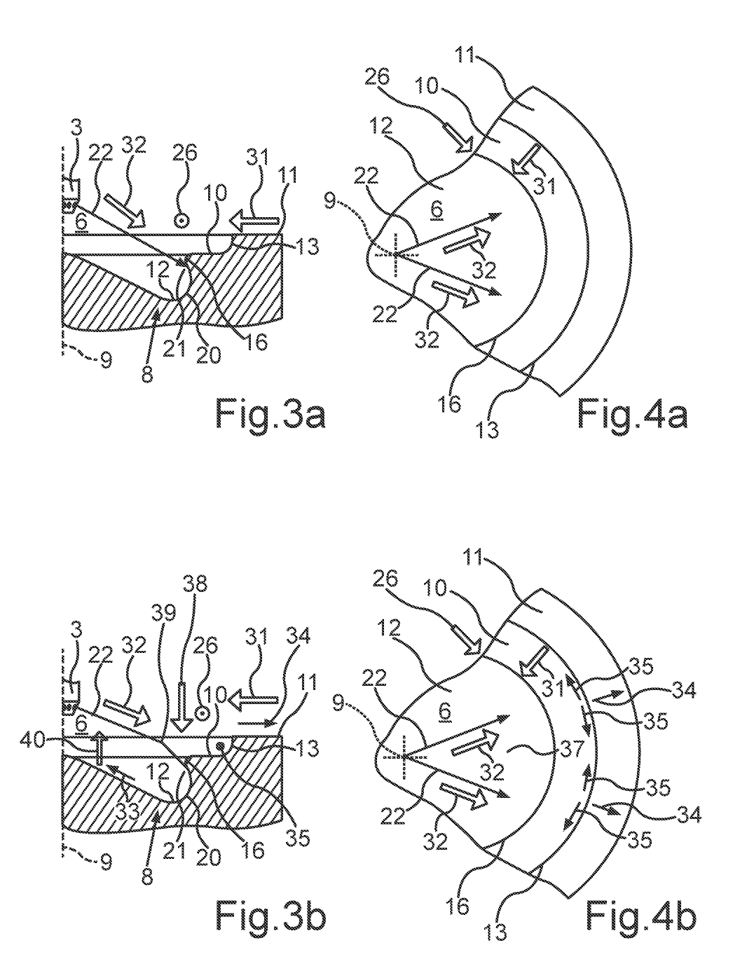

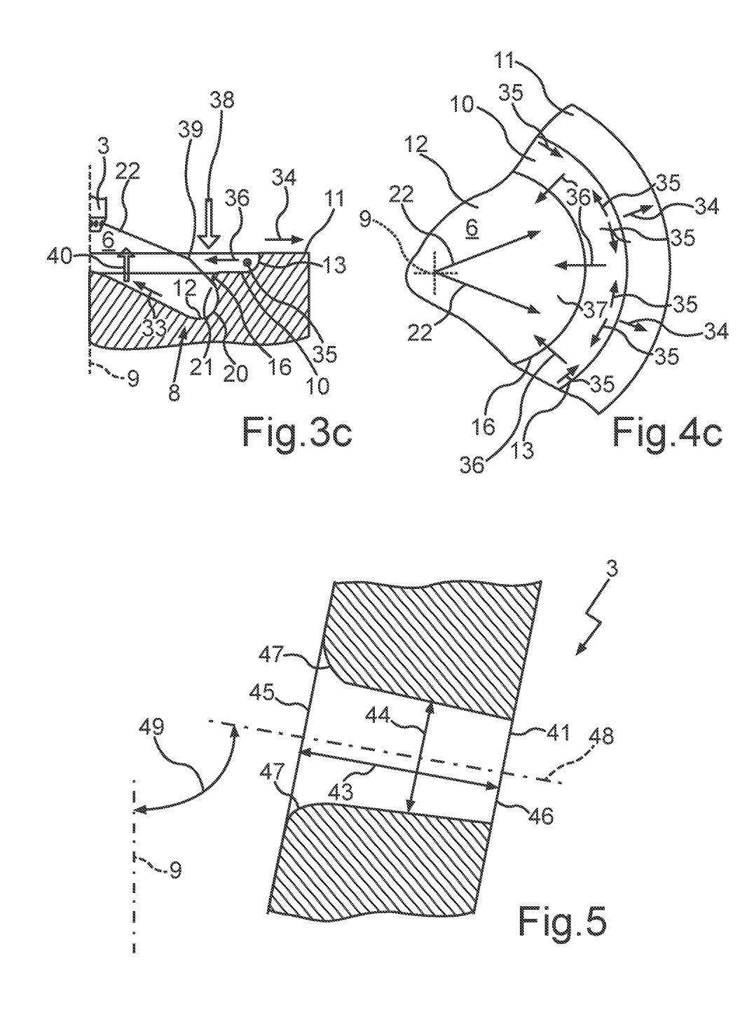

In the following, in particular with reference to FIGS. 3 and 4, a method for operating the internal combustion engine is described, wherein, within the context of the method, a combustion method is carried out, which uses self-ignition, in particular diesel or the like. The combustion method is also referred to as a burning method. In order to set up the combustion process, a charge exchange conventionally takes place in the particular cylinder 2 so that a charge of fresh air or a charge or fresh air and recirculated exhaust gas is then present in the particular combustion chamber 6. The charge of fresh air or of fresh air and recirculated exhaust gas in the combustion chamber 6 is also subjected to a swirl 26, which is shown in FIG. 4a to FIG. 4c by a block arrow. The swirl 26 or the swirl flow therefore corresponds to a rotation of the charge about the central longitudinal axis 9, i.e., a flow in the circumferential direction. In the following, all flows or the essential direction vectors of the individual flows of the charge in the combustion chamber 6 are symbolized by block arrows.

In the following, the injected fuel, i.e., the injection jet 22 and the portions separating therefrom, are symbolized by simple arrows. The arrows symbolize the essential direction vectors.

As shown in FIG. 1, during the compression stroke the piston 8 maximally approximates the cylinder head 5, as a result of which a squish clearance 28 is axially formed between the piston crown 11 and an annular region 27 of the cylinder head 5 that is axially opposite the piston crown 11, which gap has a squish clearance length 29 measured in the radial direction and a squish clearance height 30 measured in the axial direction. The squish clearance length 29 substantially corresponds to the radial distance between the cylinder wall 7 and the step wall 13 in this case. The squish clearance height 30 corresponds to the axial distance between the annular region 27 and the piston crown 11 in the upper dead center of the piston 8 in this case.

In the region of the upper dead center, the piston 8 produces, by moving towards the cylinder head 5, a squish clearance flow 31 that is known per se and is shown in FIGS. 3a to 3c by a block arrow. The squish clearance flow 31 is oriented substantially radially towards the longitudinal axis 9. It is clear that a squish clearance flow 31 cannot form in a piston 8 that moves away from the cylinder head 5. However, due to the inertia of the charge in the combustion chamber 6 or the proportion of the charge in the combustion chamber 6, which is subjected to the squish clearance flow 31, when the piston 8 moves downwards, the squish clearance flow 31 formed during the compression stroke is still present and is active at least until the end of the injection process.

According to FIGS. 3a and 4a, the injection nozzle 3 simultaneously produces a plurality of injection jets 22 for a combustion process during self-ignition operation, which jets propagate into the combustion chamber 6 in the shape of a star. In this case, the injection jets 22 are adapted to the position of the piston 8 with regard to the jet cone angle 24 at the time of injection such that the injection jets 22 do not directly impinge on the jet splitter contour 16 but impinge thereon eccentrically, in particular moved towards the undercut 21 or towards the outer wall 20 of the piston bowl 12, so that they lie in the region between the outer wall 20 and the jet splitter contour 16. In FIG. 1, this is clearly shown by the central longitudinal axis 23 of the injection jets 22 when the injection jets 22 begin impinging on the jet splitter contour 16. At this point, the swirl flow 26, the squish clearance flow 31 and a jet flow 32 are present in the combustion chamber 6. The jet flow 32 is a flow of the charge that is produced by the entrainment of the combustion air surrounding the injection jets 22. The jet flow 32 is symbolized by a block arrow between the injection jet 22 and the cylinder head 5 and comprises a distinct direction vector which extends substantially in parallel with the central longitudinal axis 23 of the injection jet 22. The swirl 26 comprises a distinct direction vector which is oriented tangentially to the central longitudinal axis 9 or to the piston 8, symbolized by its block arrow. The squish clearance flow 31 has a distinct direction vector that extends transversely to the direction of the central longitudinal axis 9, symbolized by its block arrow.

According to FIGS. 3b and 4b, the injection jet 22 impinging on the jet splitter contour 16 is divided into a first portion 33, a second portion 34 and third portions 35 during the subsequent stages of the combustion process. In this case, the piston 8 has moved further away from the cylinder head 5 or the injection nozzle 3 so that when the injection jet 22 impinges on the jet splitter contour 16, it now migrates towards the center of the jet splitter contour 16 or the step bottom 15. The first portion 33 enters the piston bowl 12. The second portion 34 flows over the piston step 10 and onto the piston crown 11, towards the cylinder wall 7 and of the cylinder head 5 or the annular region 27 of the cylinder head 5. The third portions 35 flow along in the piston step 10 from the central longitudinal axis 23 of the injection jet 22 in opposite directions to one another in the piston step 10. When the third portions 35 impinge on the step wall 13, they are separated and flow to the left and to the right out of the injection jet 22. In FIGS. 3b to 3c, the substantial direction vectors of the third portions 35 are shown by large points and the essential direction vector of the swirl 26 is shown by a circle with a dot in the middle. In FIGS. 4b and 4c, the first portions 33 have not been shown for reasons of clarity. The first portion 33 forms a first essential flame front in the combustion chamber 6. The second portion 34 forms a second essential flame front in the combustion chamber 6. In this case, the fuel that has split off from the injection jet 22 has substantially mixed with the combustion air in the combustion chamber 6 and ignited.

According to FIG. 4c, in the subsequent stages of combustion, two injection jets 22 that are adjacent in the circumferential direction can now collide inside the piston step 10 with a third portion 35 of one injection jet 22 and with a third portion 35 of the adjacent injection jet 22 in the circumferential direction and can join together to form a third combustion front 36, which radially propagates away from the step wall 13 of the piston step 10, radially inwards into a gap 37, which is formed between two adjacent injection jets 22 in the circumferential direction in each case. The third portions 35 that join together two adjacent injection jets 22 form the third essential flame front in the combustion chamber 6.

Therefore, a total of three essential, spatially propagating flame fronts are present in the combustion chamber 6, and therefore the combustion method can be consequently referred to as a 3-front combustion method.

In order to stably form the third combustion front 36, it is important for the third portions 35 to have sufficient fuel mass and a high speed for a sufficiently high momentum. This is assisted by the guidance according to the invention of the injection jet 22 from the piston 8 that moves away from the cylinder head 5. By means of the guidance, the fuel introduced into the combustion chamber 6 by means of the injection jet 22 can furthermore impinge on the jet splitter contour 16 such that the fuel can be optimally divided to form the three portions 33, 34, 35. According to the invention, the respective essential direction vectors of the swirl 26, the squish clearance flow 31 and the jet flow 32 form a resultant flow 38. The resultant flow 38 comprises at least one essential direction vector or an essential flow component, which forms in the region between the injection jet 22 and the cylinder head 5, symbolized in FIGS. 3b and 3c by a block arrow 38. According to FIGS. 3b and 3c, the resultant flow (block arrow 38) now precisely impinges on the particular injection jet 22 upstream or above the jet of the jet splitter contour 16 and deflects it towards the piston 8. As a result, with regard to the impingement of the injection jet 22 on the jet splitter contour 16, the injection jet can follow the movement of the piston 8 in a manner guided to some extent by the resultant flow 38, which piston is already in its expansion stroke and accordingly moves further and further away from the cylinder head 5. In this case, the flow-dynamic guidance or deflection of the injection jet 22 towards the piston 8 achieved here always takes place at the right time after the initial impingement of the injection jet 22 on the jet splitter contour 16.

In order to illustrate the different flows 26, 31 and 32 and the resultant flow 38 formed therefrom or the essential direction vector shown in FIGS. 3b and 3c, in FIG. 3b all the flows 26, 31, 32 and 38 are illustrated as block arrows. For reasons of clarity, in FIG. 3c only the resultant flow 38 that is essential to the invention is indicated and FIG. 4c does not indicate a flow. The resultant flow 38 causes the injection jets 22 to be guided from the piston 8 that moves away from the cylinder head 5 or the injection nozzle 3, whereby the injection jet 22 is deflected or curved above the jet of the jet splitter contour 16 towards the piston 8 by means of the resultant flow 38. In each of FIGS. 3b and 3c, the continuous curvature of the injection jet 22 is symbolized by a bend in the jet 39 for reasons of clarity.

It should be pointed out that the 3-front combustion method ensures a combustion process in which three combustion fronts can be continuously supplied with fuel or a mixture of fuel and the charge in the combustion chamber 6 until the injection process finishes. In this case, the first combustion front and the second combustion front form first of all, followed by the third combustion front 36. Within the chronological sequence of these continuous processes, the injection jet 22 sweeps the jet splitter contour 16 until the injection jet 22 eventually impinges more or less exactly on the jet splitter contour 16 in the direction of the step bottom 15 or on the step bottom 15. During this process, the resultant flow 38 forms, which forces the central longitudinal axis 23 of the injection jet 22 further into the region of the jet splitter contour 16 so that the central longitudinal axis 23 of the injection jet 22 cannot sweep the step wall 13 or may even impinge on the piston crown 11, as a result of which the second portion or combustion front 34 remains relatively small and does not substantially touch the cylinder wall 7, and a sufficiently large amount of fuel is available for the third portions 35.

FIGS. 3a to 3c and FIGS. 4a to 4c show the injection jet 22 impinging on the piston 8 and an injection jet 22 being divided up into its three portions 33, 34, 35, which applies to large injected amounts having correspondingly long injection times, of course depending on the injection pressure and injection start. If the amount injected is smaller than, for example, during full-load operation of the internal combustion engine, the duration of the injection process is in general also correspondingly shorter. In this case, the injection jet 22 may only sweep part of the jet splitter contour 16, as shown in FIG. 3b, before the injection process has finished. In this case, the resultant flow 38 according to the invention also acts on such an injection jet 22, even though the jet does not impinge on the jet splitter contour 16, in a manner displaced towards the piston step 10, once it has finished being injected. The third combustion front 36 can, as shown in FIG. 4c, still be formed, since the injection jet 22 has a club contour 25, i.e., a club-shaped mixture cloud having a club contour 25 surrounds the central longitudinal axis 23 of the injection jet 22 and this mixture cloud is divided at the jet splitter contour 16 into the first amount 33, which flows into the piston bowl 12, and into the second portion 34 and the third portions 35, which flow towards the piston step 10.

The piston bowl 12 below the jet splitter contour 16 comprises an undercut 21 in the region of the outer wall 20. By means of the substantially radially formed undercut 21, the first portions 33 of the respective injection jets 22, which portions enter the piston bowl 12, are deflected in the region of the undercut 21 so that the first portions 33 leave the undercut 21 transversely to the direction of the central longitudinal axis 9. This leads at least to the propagation of the first portions 33 substantially in parallel with the piston cone 17. In this case, the first portion 33 can also easily separate from the piston cone 17, since a longitudinal flow 40 may occur in the combustion chamber 6, which flow has a distinct direction vector that is oriented substantially in parallel with the central longitudinal axis 9 in the direction of the cylinder head 5, and deflects the first portions 33 towards the cylinder head 5. The longitudinal flow 40 is indicated by a block arrow in FIGS. 3b and 3c. In FIGS. 3b and 3c, this detaching of the first combustion front is symbolized by an arrow pointing away from the piston cone 17. Advantageously, contact between the first portions 33 and the piston cone 17 can therefore be significantly reduced so that heat cannot be removed from the first portions 33 by contact with the piston 8 in the region of the piston cone 17 and improved mixing with the charge in the combustion chamber 6 can take place, which again improves the efficiency of the combustion process overall.

In order to implement the 3-front combustion method presented here that involves suitable deflection of the particular injection jet 22, which is provided temporally with respect to the position of the piston 8, has proven to be especially advantageous when the particular injection nozzle 3 comprises from seven to twelve, preferably from ten to twelve, in particular ten injection holes 41, one of which is shown in FIG. 5 by way of example. Accordingly, the particular injection nozzle 3 can generate from seven to twelve or from ten to twelve injection jets 22, preferably precisely ten.

The injection holes 41 in the injection nozzle 3 are also referred to as injection openings and are oriented with respect to the central longitudinal axis 9 such that the jet cone angle 24 can lie in an angular range of from approximately 140° to approximately 160 °, for example. However, a jet cone angle of 152°±1° is preferred.

The swirl 26 expediently moves in an iTheta range, which ranges from approximately 0.3 to approximately 4.5, and preferably from approximately 0.8 to 2.5. It is known that this swirl number iTheta can be determined using the rectifier swirl measurement method according to Tippelmann, for example.

In this case, typical means for generating a swirl are the arrangement and orientation of an intake port and the arrangement of an intake opening. Likewise, a valve seat of an intake valve can be designed to generate a swirl. In addition, it is known to provide swirl flaps in intake ports. The possibilities of generating a swirl are well known and will not be discussed further in detail.

The squish clearance 28 can expediently have a squish clearance height 30, which can be in the range of from approximately 0.3% to approximately 2.5% of the piston diameter (shown in FIG. 2 by reference numeral 42). The squish clearance height 30 preferably lies in a range of from 0.5% to approximately 1.2% of the piston diameter 42.

The squish clearance length 29 expediently lies in a range of from approximately 6% to approximately 22% of the piston diameter 42 and preferably lies in a range of from approximately 9% to approximately 14% of the piston diameter 42.

According to FIG. 5, the particular injection hole 41 has a hole length 43 and a hole diameter 44. A ratio of the hole length 43 to the hole diameter 44, which is in a range of from approximately 2.5 to approximately 10.0 and preferably in a range of from approximately 3.0 to approximately 7.0, has proven to be especially advantageous. In the example shown in FIG. 5, the particular injection hole 41 is conical so as to taper from an inlet side 45 to an outlet side 46. Accordingly, the hole diameter 44 changes along the hole length 43. In particular, the hole diameter 44 on the inlet side 45, optionally downstream of a rounded portion 47, can be from approximately 2% to approximately 25%, preferably from approximately 5% to approximately 15%, larger than the hole diameter 44 on the outlet side 46. The injection hole 41 shown in FIG. 5 comprises a rounded portion 47 on its inlet side 45, which can be produced by means of hydraulic erosion, for example.

A central longitudinal axis 48 of the particular injection hole 41 defines the central longitudinal axis 23 of the injection jet 22 and forms an angle 49 together with the central longitudinal axis 9 of the cylinder 2, which is half the size of the jet cone angle 24. The self-igniting combustion method envisaged here is intended for direct-injection internal combustion engines. It can preferably be formed in diesel engines. In principle, it is also conceivable to carry out the self-igniting combustion method envisaged here in petrol engines and gas engines, provided these use direct injection.

In order to now achieve operation of the internal combustion engine that is particularly advantageous with regards to efficiency, i.e., to achieve particularly high efficiency and to thereby be able to minimize the nitrogen oxide (NOₓ) emissions and soot emissions at the same time, the method and therefore the 3-front combustion method provides that, when the fuel is injected into the combustion chamber 6 of an internal combustion engine, the fuel flows through the injection element (injection nozzle 3) with a hydraulic flow (HD) of more than 1000 cm³(cubic centimeters) per 60 seconds and under an injection pressure of 100 bar and 1 liter capacity per cylinder for truck applications, and a hydraulic flow (HD) of more than 1900 cm³ cubic centimeters per 60 seconds and under an injection pressure of 100 bar and 1 liter capacity per cylinder for car applications. In other words, the hydraulic flow of the fuel through the injection element is, based on an injection pressure of 100 bar, more than 1000 cm³ or 1900 cm³ per 60 seconds standardized to 1 liter capacity for a cylinder. Furthermore, it is preferable for the combustion chamber 6 to have a compression ratio of at least 20, in particular at least 20.5, for truck applications, the compression ratio, for example, which is also indicated by ε, being 20.3, for example. For car applications, the compression ratio can likewise be increased by approximately 1 to 2 units, from 15.5 to 17.5, for example.

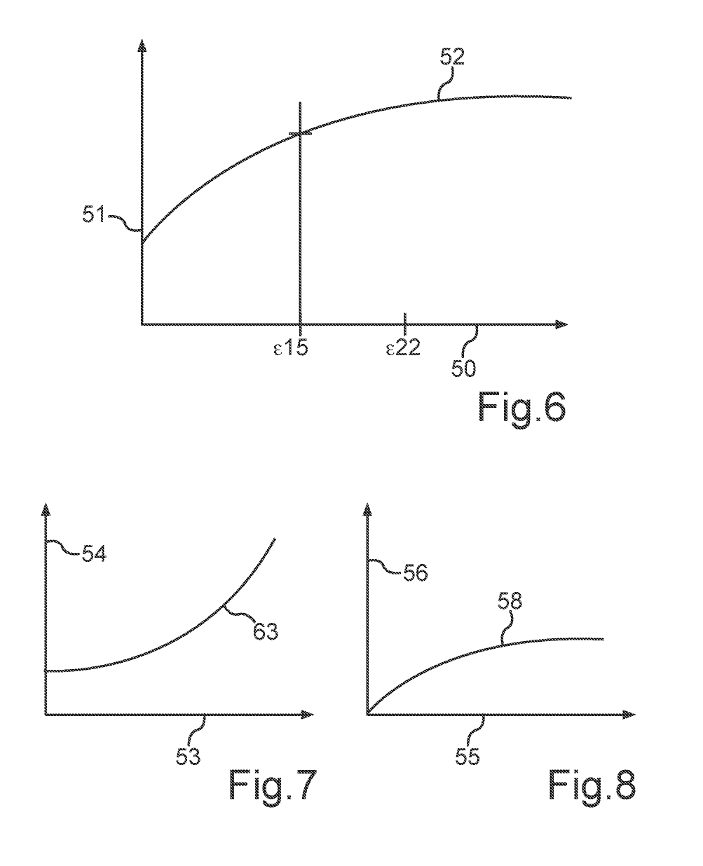

FIG. 6 shows a graph, on the x-axis 50 of which the compression ratio of the combustion chamber 6 is plotted. The efficiency, in particular the thermal efficiency ηₜₕ of the internal combustion engine 1 is plotted on the y-axis 51 of the graph shown in FIG. 6. A curve 52 recorded in the graph shows the thermal efficiency as a function of the compression ratio. It can be seen from FIG. 6 that, by increasing the compression ratio, the efficiency or thermal efficiency can be increased. In comparison with conventional internal combustion engines, an increase in the compression ratio of the combustion chamber 6 is possible, since the effective mixing of fresh air, recirculated exhaust gas (EGR) and fuel of the three-front combustion method also provides low soot emissions together with high compression ratios. By using the 3-front combustion method, the hydraulic flow of the injection element can be considerably higher than 1000 cm³ per 60 seconds under an injection pressure of 100 bar and 1 liter capacity per cylinder for truck applications, and considerably higher than 1900 cm³ per 60 seconds under an injection pressure of 100 bar and 1 liter capacity per cylinder for car applications, without leading to an excessive increase in nitrogen oxide and soot emissions.

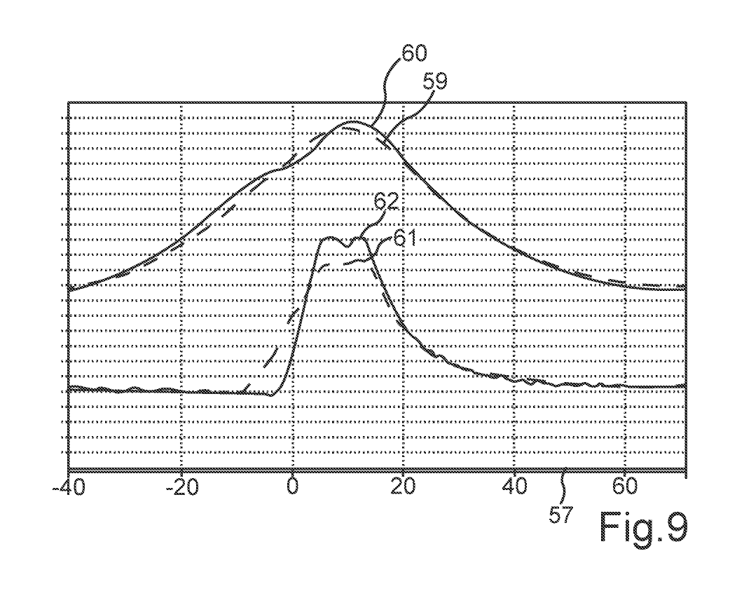

FIG. 7 shows a graph, on the x-axis 53 of which the temperature prevailing in the combustion chamber 6 is plotted. The nitrogen oxides in the exhaust gas are plotted on the y-axis 54 of the graph shown in FIG. 7. It can be seen from a curve 63 in FIG. 7 that, as the temperature increases, the nitrogen oxide emissions increase. An excessive increase in nitrogen oxide emissions in the combustion chamber 6 can, however, be avoided by using the 3-front combustion method in combination with the high compression ratio and the high hydraulic flow, which can be seen in FIG. 8. FIG. 8 shows a graph, on the x-axis 55 of which time is plotted. Nitrogen oxides are plotted on the y-axis 56 of the graph shown in FIG. 8. It can in particular be seen from a curve 58 in FIG. 8 that the nitrogen oxides can be minimized when the fuel injected into the combustion chamber 6 is converted very quickly, i.e., can be combusted. By using the 3-front combustion method and using an injection element having a high hydraulic flow, the fuel injected into the combustion chamber 6 can be converted very quickly, i.e., in a particularly short amount of time, so that, despite the high compression ratio, overly high nitrogen oxide and soot emissions can be avoided. As a result, particularly high efficiency of the internal combustion engine can be achieved without leading to overly high nitrogen oxide and soot emissions.

FIG. 9 shows another graph, on the x-axis 57 of which the crank angle is plotted. In FIG. 9, a curve 59 illustrates the cylinder pressure of a conventional internal combustion engine, a curve 60 illustrating the cylinder pressure in the combustion chamber 6 of the internal combustion engine 1. Furthermore, a curve 61 illustrates the combustion and therefore the above-described conversion of the fuel in a conventional internal combustion engine, a curve 62 illustrating the combustion of the internal combustion engine 1 and therefore the conversion of the fuel injected into the combustion chamber 6. It can be seen from FIG. 9 that, by means of the high hydraulic flow of the injection element, the burn time can be considerably shorter than in conventional internal combustion engines, and therefore the combustion method approximates an efficiency-optimal Otto cycle in which the injected fuel burns as quickly as possible. Due to the short burn time, there is only a small amount of time for nitrogen oxides to form in the combustion chamber 6 or the relatively slow formation of NOₓ is stopped since the combustion process ends quicker.

The described method can help overcome the preconception that the injection element can only be used for truck applications or car applications up to a certain hydraulic flow. By means of the described method, injection nozzles having higher hydraulic flows (HD) than previously anticipated can be used and shorten the burn time, leading to a quicker combustion process. The earlier understanding that the hydraulic flow has to be limited due to too high soot emissions in internal combustion engines to a maximum of 1000 cm³ per 60 seconds under an injection pressure of 100 bar and 1 liter capacity per cylinder for truck applications and to a maximum of 1900 cm³ per 60 seconds under an injection pressure of 100 bar and 1 liter capacity per cylinder for car applications is debunked by the three-front combustion method. Furthermore, a particularly high compression ratio of at least 20.3, and preferably at least 20.5, can be achieved for truck applications, and a compression ratio that is approximately 1 to 2 units greater can be achieved for car applications. This can allow for particularly high thermal efficiency.

1.-5. (canceled)

6. A method for operating an internal combustion engine, wherein the internal combustion engine, comprises:
a cylinder that has a combustion chamber;
a piston that is translationally movable in the cylinder;
wherein the combustion chamber is laterally delimited by a cylinder wall, axially delimited on a first side by a cylinder head, and axially delimited on a second side by the piston;
wherein the piston has an annually circumferential piston step which is axially sunk in the piston with respect to an annularly circumferential piston crown and which transitions via an annularly circumferential jet splitter contour into a piston bowl that is axially sunk in the piston with respect to the piston step; and
an injection element assigned to the cylinder;
and comprising the steps of:
injecting a fuel into the combustion chamber by the injection element by injecting a plurality of injection jets into the combustion chamber at a same time in a shape of a star for a combustion process during a self-ignition operation;
wherein the plurality of injection jets are each divided up at the jet splitter contour into a first fuel portion, a second fuel portion, and a third fuel portion;
wherein the first portion enters the piston bowl, the second portion enters a region between the piston crown and the cylinder head via the piston step, and the third portion propagates on both sides in opposite directions in a circumferential direction along the piston step and collides with a respective third portion of an adjacent injection jet inside the piston step and is deflected radially inward;
wherein the first portion forms a first combustion front, the second portion forms a second combustion front, and the third portion forms a third combustion front of a 3-front combustion method;
wherein when the fuel is injected into the combustion chamber:
the fuel flows through the injection element with a hydraulic flow of more than 1000 cubic centimeters per 60 seconds and under an injection pressure of 100 bar and 1 liter capacity per cylinder if the internal combustion engine is used in a truck application; and
the fuel flows through the injection element with a hydraulic flow of more than 1900 cubic centimeters per 60 seconds and under an injection pressure of 100 bar and 1 liter capacity per cylinder if the internal combustion engine is used in a car application.

7. The method according to claim 6, wherein the internal combustion engine is used in the car application in a transporter having a permissible overall weight of up to 3.5 tons.

8. The method according to claim 6, wherein the internal combustion engine is used in the truck application and has a compression ratio assigned to the combustion chamber of at least 20.

9. The method according to claim 5, wherein the internal combustion engine is used in the car application and has a compression ratio assigned to the combustion chamber that is from 1 to 2 units higher than in a conventional internal combustion engine.

10. An internal combustion engine of a motor vehicle that performs the method according to claim 6, wherein the motor vehicle is a car.

11. An internal combustion engine of a motor vehicle that performs the method according to claim 6, wherein the motor vehicle is a truck.
